(19) United States
(12) Patent Application Publication
(10) Pub. No.: US 2025/0071575 A1
(43) Pub. Date: Feb. 27, 2025

(54) ITERATIVE LEARNING PROCESS IN PRESENCE OF INTERFERENCE

(71) Applicant: Telefonaktiebolaget LM Ericsson (publ), Stockholm (SE)

(72) Inventors: Henrik RYDÉN, Stockholm (SE); Reza MOOSAVI, Linköping (SE); Erik G. LARSSON, Linköping (SE)

(21) Appl. No.: 18/726,979

(22) PCT Filed: Feb. 9, 2022
(86) PCT No.: PCT/EP2022/053060

§ 371 Date: Jul. 5, 2024

(51) Int. Cl. H04W 24/02; H04B 17/309; H04W 52/24; H04W 52/36

(52) U.S. Cl. CPC H04W 24/02; H04B 17/346; H04W 52/243; H04W 52/367

(57) ABSTRACT

A method for iterative learning is performed by a server entity communicating with the agent entities over a radio propagation channel. An estimate of a level of interference of the radio propagation channel is obtained. An estimate of an acceptable level of interference for performing at least one iteration of the iterative learning process with the agent entities is obtained. An interference mitigating network operation is selected from a set of available interference mitigating network operations. The interference mitigating network operation is selected as a function of the estimate of the acceptable level of interference and the estimate of the level of interference. In accordance with the interference mitigating network operation, at least one of the server entity, the agent entities, a network node causing the level of interference level, is configured. At least one iteration of the iterative learning process is performed with the agent entities.

### TECHNICAL FIELD

Embodiments presented herein relate to a method, a server entity, a computer program, and a computer program product for performing an iterative learning process with agent entities. Embodiments presented herein further relate to a method, an agent entity, a computer program, and a computer program product for performing an iterative learning process with the server entity.

### BACKGROUND

The increasing concerns for data privacy have motivated the consideration of collaborative machine learning systems with decentralized data where pieces of training data are stored and processed locally by edge user devices, such as user equipment. Federated learning (FL) is one non-limiting example of a decentralized learning topology, where multiple (possible very large number of) agents, for example implemented in user equipment, participate in training a shared global learning model by exchanging model updates with a centralized parameter server (PS), for example implemented in a network node.

FL is an iterative process where each global iteration, often referred to as communication round, is divided into three phases: In a first phase the PS broadcasts the current model parameter vector to all participating agents. In a second phase each of the agents performs one or several steps of a stochastic gradient descent (SGD) procedure on its own training data based on the current model parameter vector and obtains a model update. In a third phase the model updates from all agents are sent to the PS, which aggregates the received model updates and updates the parameter vector for the next iteration based on the model updates according to some aggregation rule. The first phase is then entered again but with the updated parameter vector as the current model parameter vector.

A common baseline scheme in FL is named Federated SGD, where in each local iteration, only one step of SGD is performed at each participating agent, and the model updates contain the gradient information. A natural extension is so-called Federated Averaging, where the model updates from the agents contain the updated parameter vector after performing their local iterations.

The above baseline schemes are based on the participating agents using direct analog modulation when sending their model updates. This is sometimes referred to as over-the-air federated learning. Such direct analog modulation, and thus also over-the-air federated learning, is susceptible to interference.

### SUMMARY

An object of embodiments herein is to address the above issues in order to enable efficient communication between the agents (hereinafter denoted agent entities) and the PS (hereinafter denoted server entity) in scenarios impacted by interference.

According to a first aspect there is presented a method for performing an iterative learning process with agent entities. The method is performed by a server entity. The server entity is communicating with the agent entities over a radio propagation channel. The method comprises obtaining an estimate of a level of interference of the radio propagation channel. The method comprises obtaining an estimate of an acceptable level of interference for performing at least one iteration of the iterative learning process with the agent entities. The method comprises selecting an interference mitigating network operation from a set of available interference mitigating network operations. The interference mitigating network operation is selected as a function of the estimate of the acceptable level of interference and the estimate of the level of interference. The method comprises configuring, in accordance with the interference mitigating network operation, at least one of the server entity, the agent entities, a network node causing the level of interference level. The method comprises performing at least one iteration of the iterative learning process with the agent entities.

According to a second aspect there is presented a server entity for performing an iterative learning process with agent entities. The server entity is configured to communicate with the agent entities over a radio propagation channel. The server entity comprises processing circuitry. The processing circuitry is configured to cause the server entity to obtain an estimate of a level of interference of the radio propagation channel. The processing circuitry is configured to cause the server entity to obtain an estimate of an acceptable level of interference for performing at least one iteration of the iterative learning process with the agent entities. The processing circuitry is configured to cause the server entity to select an interference mitigating network operation from a set of available interference mitigating network operations. The interference mitigating network operation is selected as a function of the estimate of the acceptable level of interference and the estimate of the level of interference. The processing circuitry is configured to cause the server entity to configure, in accordance with the interference mitigating network operation, at least one of the server entity, the agent entities, a network node (180) causing the level of interference level. The processing circuitry is configured to cause the server entity to perform at least one iteration of the iterative learning process with the agent entities.

According to a third aspect there is presented a server entity for performing an iterative learning process with agent entities. The server entity is configured to communicate with the agent entities over a radio propagation channel. The server entity comprises an obtain module configured to obtain an estimate of a level of interference of the radio propagation channel. The server entity comprises an obtain module configured to obtain an estimate of an acceptable level of interference for performing at least one iteration of the iterative learning process with the agent entities. The server entity comprises a select module configured to select an interference mitigating network operation from a set of available interference mitigating network operations. The interference mitigating network operation is selected as a function of the estimate of the acceptable level of interference and the estimate of the level of interference. The server entity comprises a configure module configured to configure, in accordance with the interference mitigating network operation, at least one of the server entity, the agent entities, a network node causing the level of interference level. The server entity comprises a process module configured to perform at least one iteration of the iterative learning process with the agent entities.

According to a fourth aspect there is presented a computer program for performing an iterative learning process with agent entities, the computer program comprising computer program code which, when run on processing circuitry of a server entity, causes the server entity to perform a method according to the first aspect.

According to a fifth aspect there is presented a method for performing an iterative learning process with a server entity. The method is performed by an agent entity. The agent entity is communicating with the server entity over a radio propagation channel. The method comprises receiving instructions from the server entity to estimate the acceptable level of interference for the iterative learning process. The method comprises estimating the acceptable level of interference for the iterative learning process. The method comprises reporting the estimated acceptable level of interference to the server entity. The method comprises performing at least one iteration of the iterative learning process with the server entity. The at least one iteration is performed based on an interference mitigating network operation as determined as a function of the estimated acceptable level of interference.

According to a sixth aspect there is presented an agent entity for performing an iterative learning process with a server entity. The agent entity is configured to communicate with the server entity over a radio propagation channel. The agent entity comprises processing circuitry. The processing circuitry is configured to cause the agent entity to receive instructions from the server entity to estimate the acceptable level of interference for the iterative learning process. The processing circuitry is configured to cause the agent entity to estimate the acceptable level of interference for the iterative learning process. The processing circuitry is configured to cause the agent entity to report the estimated acceptable level of interference to the server entity. The processing circuitry is configured to cause the agent entity to perform at least one iteration of the iterative learning process with the server entity. The at least one iteration is performed based on an interference mitigating network operation as determined as a function of the estimated acceptable level of interference.

According to a seventh aspect there is presented an agent entity for performing an iterative learning process with a server entity. The agent entity is configured to communicate with the server entity over a radio propagation channel. The agent entity comprises a receive entity configured to receive instructions from the server entity to estimate the acceptable level of interference for the iterative learning process. The agent entity comprises an estimate entity configured to estimate the acceptable level of interference for the iterative learning process. The agent entity comprises a report entity configured to report the estimated acceptable level of interference to the server entity. The agent entity comprises a process entity configured to perform at least one iteration of the iterative learning process with the server entity. The at least one iteration is performed based on an interference mitigating network operation as determined as a function of the estimated acceptable level of interference.

According to an eighth aspect there is presented a computer program for performing an iterative learning process with a server entity, the computer program comprising computer program code which, when run on processing circuitry of an agent entity, causes the agent entity to perform a method according to the fifth aspect.

According to a ninth aspect there is presented a computer program product comprising a computer program according to at least one of the fourth aspect and the eighth aspect and a computer readable storage medium on which the computer program is stored. The computer readable storage medium could be a non-transitory computer readable storage medium.

Advantageously, these aspects provide efficient communication between the server entity and the agent entities so that the server entity can obtain updates from all agent entities, even in situations of high interference.

Advantageously, these aspects provide robust communication between the server entity and the agent entities in the presence of high interference.

Advantageously, these aspects provide robustness to over-the-air federated learning by considering the acceptable level of interference for the iterative learning process when selecting the interference mitigating network operation.

Advantageously, application of these aspects achieves faster convergence of the iterative learning process than in the absence of these aspects.

Advantageously, these aspects provide efficient use of radio resources since the interference mitigating network operation only is executed on a per-need basis. One can for example expect that an FL-model can tolerate more noise in the early stages of training in comparison to the fine-tuning of model weights.

Advantageously, these aspects enable different types of interference mitigating network operations to be performed, depending on the circumstances.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communication network according to embodiments;

FIG. 2 is a signalling diagram according to an example;

FIGS. 3, 4, 5, and 6 are flowcharts of methods according to embodiments;

FIG. 7 is a signalling diagram according to an embodiment;

FIG. 8 shows results according to embodiments;

FIG. 9 is a schematic diagram showing functional units of a server entity according to an embodiment;

FIG. 10 is a schematic diagram showing functional modules of a server entity according to an embodiment;

FIG. 11 is a schematic diagram showing functional units of an agent entity according to an embodiment;

FIG. 12 is a schematic diagram showing functional modules of an agent entity according to an embodiment;

FIG. 13 shows one example of a computer program product comprising computer readable means according to an embodiment;

FIG. 14 is a schematic diagram illustrating a telecommunication network connected via an intermediate network to a host computer in accordance with some embodiments; and

FIG. 15 is a schematic diagram illustrating host computer communicating via a radio base station with a terminal device over a partially wireless connection in accordance with some embodiments.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

The wording that a certain data item, piece of information, etc. is obtained by a first device should be construed as that data item or piece of information being retrieved, fetched, received, or otherwise made available to the first device. For example, the data item or piece of information might either be pushed to the first device from a second device or pulled by the first device from a second device. Further, in order for the first device to obtain the data item or piece of information, the first device might be configured to perform a series of operations, possible including interaction with the second device. Such operations, or interactions, might involve a message exchange comprising any of a request message for the data item or piece of information, a response message comprising the data item or piece of information, and an acknowledge message of the data item or piece of information. The request message might be omitted if the data item or piece of information is neither explicitly nor implicitly requested by the first device.

The wording that a certain data item, piece of information, etc. is provided by a first device to a second device should be construed as that data item or piece of information being sent or otherwise made available to the second device by the first device. For example, the data item or piece of information might either be pushed to the second device from the first device or pulled by the second device from the first device. Further, in order for the first device to provide the data item or piece of information to the second device, the first device and the second device might be configured to perform a series of operations in order to interact with each other. Such operations, or interaction, might involve a message exchange comprising any of a request message for the data item or piece of information, a response message comprising the data item or piece of information, and an acknowledge message of the data item or piece of information. The request message might be omitted if the data item or piece of information is neither explicitly nor implicitly requested by the second device.

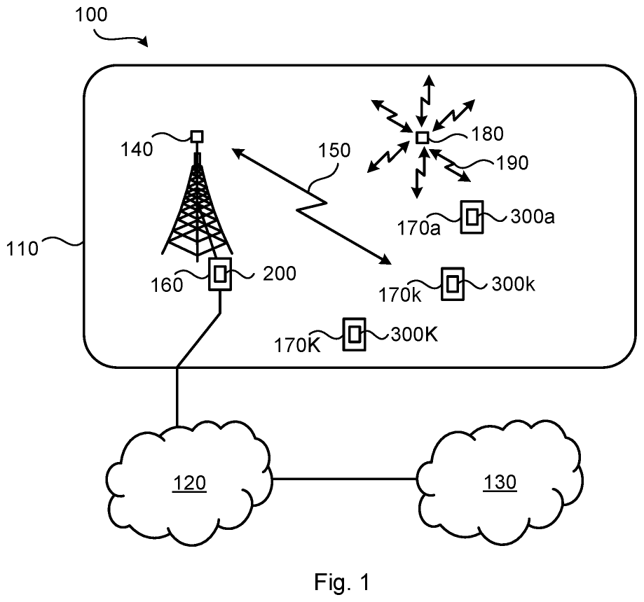

FIG. 1 is a schematic diagram illustrating a communication network 100 where embodiments presented herein can be applied. The communication network 100 could be a third generation (3G) telecommunications network, a fourth generation (4G) telecommunications network, a fifth (5G) telecommunications network, a sixth (6G) telecommunications network, and support any 3GPP telecommunications standard.

The communication network 100 comprises a transmission and reception point 140 configured to provide network access to user equipment 170a, 170k, 170K in an (radio) access network 110 over a radio propagation channel 150. The access network 110 is operatively connected to a core network 120. The core network 120 is in turn operatively connected to a service network 130, such as the Internet. The user equipment 170a:170K is thereby, via the transmission and reception point 140, enabled to access services of, and exchange data with, the service network 130.

Operation of the transmission and reception point 140 is controlled by a network node 160. The network node 160 might be part of, collocated with, or integrated with the transmission and reception point 140.

Examples of network nodes 160 are (radio) access network nodes, radio base stations, base transceiver stations, Node Bs (NBs), evolved Node Bs (eNBs), gNBs, access points, access nodes, and integrated access and backhaul nodes. Examples of user equipment 170a:170K are wireless devices, mobile stations, mobile phones, handsets, wireless local loop phones, smartphones, laptop computers, tablet computers, network equipped sensors, network equipped vehicles, and so-called Internet of Things devices.

It is assumed that the user equipment 170a:170K are to be utilized during an iterative learning process and that the user equipment 170a:170K as part of performing the iterative learning process are to report computational results to the network node 160. The network node 160 therefore comprises, is collocated with, or integrated with, a server entity 200. Each of the user equipment 170a:170K comprises, is collocated with, or integrated with, a respective agent entity 300a:300K.

A network node 180 is illustrated as causing interference 190 to the communication between the user equipment 170a:170K and the network node 160, and thus between the agent entities 300a:300K and the server entity 200. The network node 180 might comprise its own transmission and reception point (not illustrated).

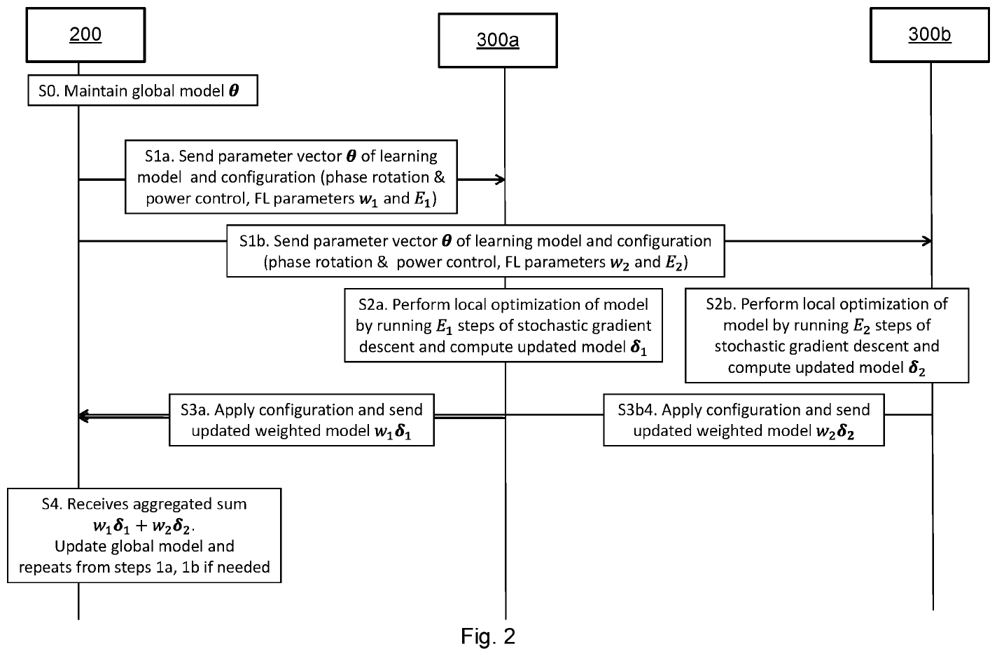

Reference is next made to the signalling diagram of FIG. 2, illustrating an examples of a nominal iterative learning process. Consider a setup with K agent entities 300a:300K, and one server entity 200. Each transmission from the agent entities 300a:300K is allocated N resource elements (REs). These can be time/frequency samples, or spatial modes. For simplicity, but without loss of generality, the example in FIG. 2 is shown for two agent entities 300a, 300b, but the principles hold also for larger number of agent entities 300a:300K.

The server entity 200 updates its estimate of the learning model (maintained as a global model θ in step S0), as defined by a parameter vector θ(i), by performing global iterations with an iteration time index i. The parameter vector θ(i) is assumed to be an N-dimensional vector. At each iteration i, the following steps are performed:

Steps S1a, S1b: The server entity 200 broadcasts the current parameter vector of the learning model, θ(i), to the agent entities 300a, 300b.

Steps S2a, S2b: Each agent entity 300a, 300b performs a local optimization of the model by running T steps of a stochastic gradient descent update on θ(i), based on its local training data;

$${θ}_{k} ( i , τ ) = {θ}_{k} ( i , τ - 1 ) - {η}_{k} ∇ {f}_{k} ( {θ}_{k} ( i , τ - 1 ) ) τ = 1 , … , T ,$$

where ηₖ is a weight and ƒₖ is the objective function used at agent entity k (and which is based on its locally available training data).

Steps S3a, S3b: Each agent entity 300a, 300b transmits to the server entity 200 their model update δₖ(i);

$${δ}_{k} ( i ) = {θ}_{k} ( i , T ) - {θ}_{k} ( i , 0 ) ,$$

where θₖ(i, 0) is the model that agent entity k received from the server entity 200. Steps S3a, S3b may be performed sequentially, in any order, or simultaneously.

Step S4: The server entity 200 updates its estimate of the parameter vector θ(i) by adding to it a linear combination (weighted sum) of the updates received from the agent entities 300a, 300b;

$$θ ( i + 1 ) = θ ( i ) + {w}_{1} {δ}_{1} ( i ) + {w}_{2} {δ}_{2} ( i )$$

where wₖ are weights.

Assume now that there are K agent entities and hence K model updates. When the model updates {δ₁, . . . , δ_{K}} (where the time index has been dropped for simplicity) from the agent entities 300a:300K over a wireless communication channel, there are specific benefits of using direct analog modulation. For analog modulation, the k:th agent entity could transmit the N components of δₖ directly over N resource elements (REs). Here an RE could be, for example: (i) one sample in time in a single-carrier system, or (ii) one subcarrier in one orthogonal frequency-division multiplexing (OFDM) symbol in a multicarrier system, or (iii) a particular spatial beam or a combination of a beam and a time/frequency resource.

One benefit of direct analog modulation is that the superposition nature of the wireless communication channel can be exploited to compute the aggregated update, δ₁+δ₂+ . . . +δ_{K}. More specifically, rather than sending δ₁, . . . , δ_{K} to the server entity 200 on separate channels, the agent entities 300a:300K could send the model updates {δ₁, . . . , δ_{K}} simultaneously, using N REs, through linear analog modulation. The server entity 200 could then exploit the wave superposition property of the wireless communication channel, namely that {δ₁, . . . , δ_{K}} add up “in the air”. Neglecting noise and interference, the server entity 200 would thus receive the linear sum, δ₁+δ₂+ . . . +δ_{K}, as desired. That is, the server entity 200 ultimately is interested only in the aggregated model update δ₁+δ₂+ . . . +δ_{K}, but not in each individual parameter vector {δ₁, . . . , δ_{K}}. This technique can thus be referred to as iterative learning with over-the-air computation.

The over-the-air computation assumes that appropriate power control is applied (such that all transmissions of {δₖ} are received at the server entity 200 with the same power), and that each transmitted δₖ is appropriately phase-rotated prior to transmission to pre-compensate for the phase rotation incurred by the channel from agent entity k to the server entity 200.

One benefit of the thus described over-the-air computation is the savings of radio resources. With two agents (K=2), 50% resources are saved compared to standard FL since the two agent entities can send their model updates simultaneously in the same RE. With K agent entities, only a fraction 1/K of the nominally required resources are needed.

As disclosed above, analog modulation as used for the transmission of the model updates with over-the-air computation is susceptible to interference.

Further in this respect, iterative learning with over-the-air computation commonly does not offer error protection. Due to the use of analog modulation, there is no error protection, or mechanism for error detection or validation of the received data, implemented in the server entity 200. This renders the communication between the server entity 200 and the agent entities 300a:300K prone to interference (e.g., as caused by the network node 180). In particular, while the network node 160 can schedule all user equipment 170a:170K and the network node 160 that participate in the iterative learning with over-the-air computation on subcarriers, resource blocks, resource elements, or other types of time/frequency resources, that are dedicated for the participating agent entities 300a:300K, there may still be interference from network nodes 180 serving other cells on those time/frequency resources. Such interference can degrade the performance of the iterative learning process.

One technique to mitigate this is to mute any other network nodes 180 in the vicinity of the cell where an iterative learning process is performed. However, this might substantially diminish the advantages of using the iterative learning process since thus muted time/frequency resources cannot be used. This can cause an overall inefficient use of resources.

In this disclosure there is therefore provided a server entity 200, a method performed by the server entity 200, a computer program product comprising code, for example in the form of a computer program, that when run on processing circuitry of the server entity 200, causes the server entity 200 to perform the method. There is further provided an agent entity 300k, a method performed by the agent entity 300k, and a computer program product comprising code, for example in the form of a computer program, that when run on processing circuitry of the agent entity 300k, causes the agent entity 300k to perform the method.

According to at least some of the herein disclosed embodiments, the acceptable level of interference when performing an iteration of an iterative learning process is determined. Based on the acceptable level of interference and the acceptable level of interference, the server entity 200 selects an interference mitigating network operation. The interference mitigating network operation can be selected to limit the overall resource usage when the iterative learning process is performed for the given circumstances.

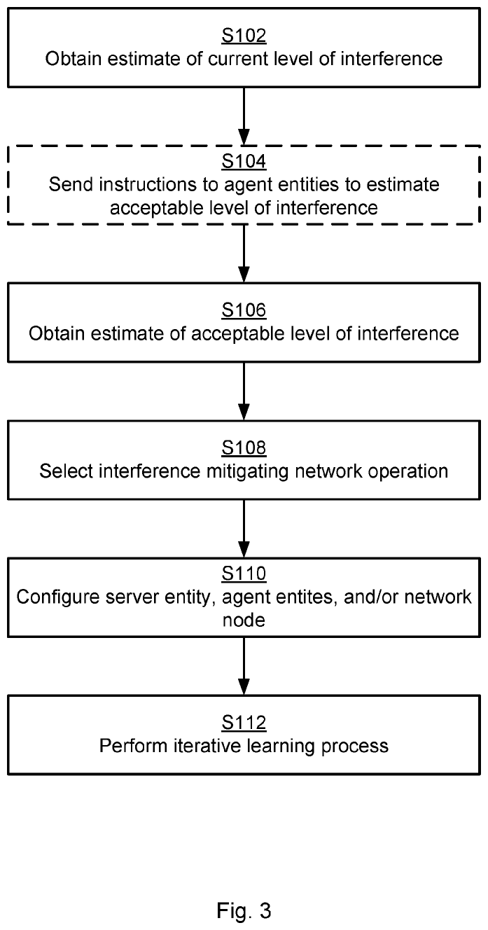

Reference is now made to FIG. 3 illustrating a method for performing an iterative learning process with agent entities 300a:300K as performed by the server entity 200 according to an embodiment. The server entity 200 is configured to communicate with the agent entities 300a:300K over a radio propagation channel.

S102: The server entity 200 obtains an estimate of a level of interference of the radio propagation channel. Examples of how the level of interference of the radio propagation channel can be estimated will be disclosed below.

S106: The server entity 200 obtains an estimate of an acceptable level of interference for performing at least one iteration of the iterative learning process with the agent entities 300a:300K. Examples of how the acceptable level of interference can be estimated will be disclosed below.

S108: The server entity 200 selects an interference mitigating network operation from a set of available interference mitigating network operations. The interference mitigating network operation is selected as a function of the estimate of the acceptable level of interference and the estimate of the level of interference. Examples of interference mitigating network operations and how the interference mitigating network operation can be selected as a function of the estimate of the acceptable level of interference and the estimate of the level of interference will be disclosed below.

S110: The server entity 200 configures, in accordance with the interference mitigating network operation, at least one of: the server entity 200, the agent entities 300a:300K, a network node 180 causing the level of interference level. Examples of how the server entity 200, the agent entities 300a:300K, and/or the network node 180 can be configured in accordance with the interference mitigating network operation will be disclosed below.

S112: The server entity 200 performs at least one iteration of the iterative learning process with the agent entities 300a:300K. Examples of how the at least one iteration of the iterative learning process can be performed will be disclosed below.

Embodiments relating to further details of performing an iterative learning process with agent entities 300a:300K as performed by the server entity 200 will now be disclosed.

Aspects of how the level of interference of the radio propagation channel can be estimated will be disclosed next.

In some non-limiting examples, the level of interference is estimated as a function of any of: scheduling information received from the network node 180, measurements on signals received from the network node 180, a historically experienced level of interference of the radio propagation channel.

In further detail, the server entity 200 might build knowledge of its interference situation by receiving scheduling information from neighboring network nodes 180 and measuring the observed interference when the server entity 200 (or the network node 200 in which the server entity 200 is provided) does not have any receiving traffic. The monitoring can be used to understand which radio equipment, such as network nodes 180 or user equipment, that can cause high interference for the server entity 200. This information can then be used to configure mitigating network operation. The server entity 200 might, for example, observe high interference from measuring on reference signals, pilot signals, or other types of signals, transmitted from the network node 180 in certain time/frequency resources. The server entity 200 might, for example, obtain information of possible high interference from scheduling information of the reference signals, pilot signals, or other types of signals to be transmitted from the network node 180. The latter information can help the server entity 200 to determine the source of the interference (i.e., to identify the network node 180) and the former information can help the server entity 200 to request the network node 180 to mute, or at least reduce transmission power, of these time/frequency resources. The server entity 200 might thereby, prior to performing an iteration of the iterative learning process with the agent entities 300a:300K, observe interference and predict the experienced interference on the iterative learning process.

The server entity 200 (or the network node 200 in which the server entity 200 is provided) might mute its own user equipment 170a:170K when performing measurements of interference from other network nodes 180. Specifically, if the server entity 200 learns that the network node 180 (or a user equipment served by the network node 180) uses a certain pilot l, then the server entity 200 can (after muting its own user equipment 170a:170K as appropriate) measure on the received power along pilot I to determine how strong the interference from the network node 180 (or a user equipment served by the network node 180) is.

If the transmission and reception point 140 of the server entity 200 is equipped with multiple antennas, the server entity 200 might also obtain the spatial characteristics of the interference. For example, by muting its own user equipment 170a:170K, the server entity 200 can determine the dominant directions from which interference is coming, and determine to what extent spatial interference suppression is possible.

Aspects of how the acceptable level of interference can be estimated will be disclosed next.

In some non-limiting examples, the acceptable level of interference is estimated as a function of any of: convergence rate of the performed iterative learning process, measurements on test data inserted in the performed iterative learning process, current number of iteration of the performed iterative learning process, variation in output between consecutive iterations of the performed iterative learning process, the convergence rate of a historically performed iterative learning process.

In further detail, the server entity 200 might estimate the need of reducing the impact of interference based on how sensitivity the model is to perturbations. The decision of how such sensitivity can be based on the listed parameters based on which the acceptable level of interference can be estimated.

The server entity 200 might monitor the convergence of the iterative learning process and determine whether to activate interference procedures. For example, the server entity 200 might activate a muting procedure in case the model has not improved in the last x iterations (for some predetermined number x), additionally using information regarding that interference has been observed, or that the neighboring network node 180 has indicated that it performs transmission/reception of data in the time/frequency resources allocated for the server entity 200 might. The model performance can be evaluated either using the model performance as reported from the agent entities on their local data, or it could be evaluated using a test data set, as described next.

The server entity 200 might communicate test data with the agent entities 300a:300K. By comparing model updates as received from the agent entities 300a:300K to ground truth data of the test data, the server entity 200 can estimate how potential perturbations (as caused by the interference) in the model weights of the model updates received from the agent entities 300a:300K can affect the performance of the iterative learning process.

Further, the server entity 200 might, if not having access to any test data, use a set of random inputs to the global model and measure how the output is sensitive to model perturbation, for example if the output statistics is different when applying a certain perturbation in comparison to no perturbation. The server entity 200 can then conclude that the performance of the iterative learning process would likely be heavily affected if such perturbation in the model weights is occurring due to interference.

With respect to historical information, the server entity 200 might compare how a model that is trained with muting of other network nodes 180 converges in comparison to other non-muted models. The server entity 200 can also receive traffic information from neighboring network nodes 180 to understand the interference situation, or to configure certain time/frequency resources to estimate the interference situation at each model update.

With respects to the number of iterations, the model might be less sensitive to interference in earlier iterations of the iterative learning process than in later iterations. This will be further illustrated below.

In some embodiments, the estimate of the acceptable level of interference is obtained either by the acceptable level of interference being estimated by the server entity 200 or by the estimate of the acceptable level of interference being received from the agent entities 300a:300K. Further in this respect, in some embodiments, the server entity 200 is configured to perform (optional) step S104:

S104: The server entity 200 sends instructions to the agent entities 300a:300K to estimate the acceptable level of interference for the iterative learning process.

The estimate of the acceptable level of interference is in S106 obtained by being received from the agent entities 300a:300K in response thereto (i.e., in response to the server entity 200 having sent the instructions in S104).

In some embodiments, the iterative learning process involves the use of a neural network, where the neural network has layers, where at least one layer is activated during each iteration of the iterative learning process, and where the acceptable level of interference is estimated as a function of which of the layers the at least one iteration of the iterative learning process pertains to.

In further detail, the server entity 200 might set the sensitivity for each layer in the neural network. This is since some layers are more important than others and may therefore be more sensitive. Typically, the final layer is most important and thus most sensitive.

Aspects of how the server entity 200, the agent entities 300a:300K, and/or the network node 180 can be configured in accordance with the interference mitigating network operation will be disclosed next.

In some aspects, the interference mitigating network operation is associated with which time/frequency resources are to be used by one of: the server entity 200, the agent entities 300a:300K, the network node 180 when the at least one iteration of the iterative learning process is performed. In some aspects, the interference mitigating network operation is then selected with a goal to identify the overall minimum number of time/frequency resources needed for the iterative learning process to be performed under the given interference conditions. In particular, in some embodiments, according to the interference mitigating network operation, a smallest set of time/frequency resources as required for maintaining the acceptable level of interference is selected.

In some aspects, the interference mitigating network operation pertains to requesting muting, or at least reduction in transmission power, of time/frequency resources in other network nodes 180. In particular, some embodiments, the interference mitigating network operation pertains to transmission power used by the network node 180. In some embodiments, the network node 180 is configured with the interference mitigating network operation by being requested to reduce transmission power in time/frequency resources causing the level of interference.

Further in this respect, there might be a negotiation between the server entity 200 and the network node 180 with respect to for which time/frequency resources the transmission power is to be reduced and/or to which level the transmission power is to be reduced. Such negotiation might involve several messages to be passed between the server entity 200 and the network node 180.

Further in this respect, the negotiation might concern some specific time/frequency resources where the network node 180 is requested to mute its transmission power. Further in this respect, the negotiation might concern limiting the maximum transmission power used by the network node 180 for serving its user equipment. Further in this respect, the negotiation might concern limiting the maximum transmission power used by the user equipment served by the network node 180. Further in this respect, the negotiation might concern muting the user equipment served by the network node 180 in some specific time/frequency resources. Further in this respect, the negotiation might concern the network node 180 to hand over some of its served user equipment to another network node, or another frequency band, where less transmission power is needed. Further in this respect, the negotiation might concern changing a time division duplex (TDD) pattern used by the network node 160 of the serve entity 200 and/or a time division duplex (TDD) pattern used by the network node 180. Further in this respect, the negotiation might concern requesting the network node 180, or user equipment served by the network node 180, to form a spatial null in the direction towards the user equipment 170a:170K in which the agent entities 300a:300K are provided and/or in the direction towards the transmission and reception point 140 of the network node 160 in which the server entity 200 is provided. Direction information needed for this purpose might by the network node 180, or user equipment served by the network node 180, be obtained from measurements on pilot signals transmitted by the user equipment 170a:170K and/or the transmission and reception point 140.

In some aspects, performing one iteration of the iterative learning process involves each of the agent entities 300a:300K to send a respective model update of the iterative learning process to the server entity 200. In some aspects, the interference mitigating network operation pertains to selecting the number of repetitions each of the local agents 300a:300K should use sending a certain model. In some embodiments, the interference mitigating network operation pertains to repetitive transmission of the model update from the agent entities 300a:300K per iteration of the iterative learning process. Hence, repetition coding of the model updates might be used. Each agent entity 300a:300K might by the server entity 200 be configured to repeat each, or a subset of, its respective gradient update components one or more times. The purpose of this is for the server entity 200 to receive at least some of the components of each model update more than one time. The server entity 200 may then average the so-obtained received values, for example by comparing the arithmetic average, the median, or some other function. Alternatively, the server entity 200 may compare the values and compute their empirical standard deviation, or evaluate a metric that identifies the presence of outliers (indicating the presence of occasional very high interference). If the so-obtained standard deviation exceeds a threshold, or outliers are detected, the server entity 200 can deem that the transmission was unreliable, and the current iteration can be repeated, or even that the iterative learning process is re-started, moved to different radio resources, or aborted.

Further in this respect, the server entity 200 might allocate a set of extra time/frequency resources for measuring the interference after each iteration. This can indicate that the iteration was subject to interference and the model update iteration, for example, should be repeated. This can be done by monitoring how the interference evolves over time. When the agent entities 300a:300K transmit the model updates, say an N-dimensional gradient vector, nominally N resource elements are needed. By augmenting this to N to N+Δ, where on the extra Δ resource elements (Δ<<N), none of the participating agent entities 300a:300K transmit anything (either send a pre-determined reference value or “transmit zero”). The server entity 200 can then validate that during these extra Δ resource elements there is no substantial interference from other transmitters or systems. If substantial interference is detected, the model updates of the recent-most iteration can be aborted, or the recent-most iteration can be repeated, either on the same time/frequency resources (but in another time slot) or on different resource elements.

In some embodiments, the interference mitigating network operation pertains to applying interference suppression when receiving the model updates from the agent entities 300a:300K during the at least one iteration of the iterative learning process. The server entity 200 might for this purpose request the transmission and reception point 140 and/or the network node 160 in which the server entity 200 is provided to apply zero-forcing interference cancellation and/or receive antenna combining to estimate the aggregated gradient update. Further, the server entity 200 might for this purpose request the transmission and reception point 140 and/or the network node 160 in which the server entity 200 is provided to form a null in the dominant direction of the interference before performing the receive antenna combining when receiving the module updates from the agent entities 300a;300K.

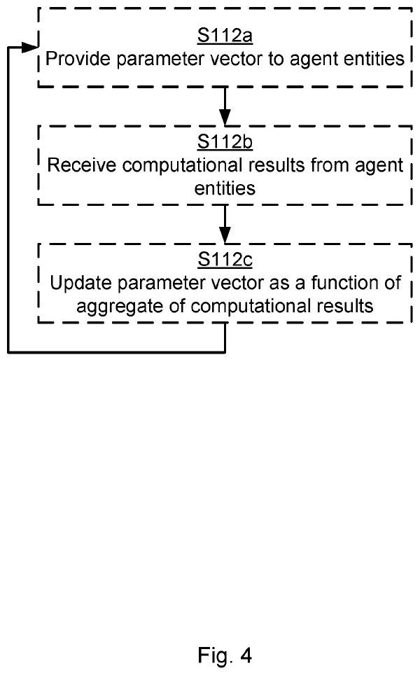

Aspects of how the at least one iteration of the iterative learning process can be performed will be disclosed next. Particular reference is here made to the flowchart of FIG. 4 showing optional steps of one iteration of the iterative learning process that might be performed by the server entity 200 during each iteration of the iterative learning process in S112.

S112a: The server entity 200 provides a parameter vector of the computational task to the agent entities 300a:300K.

S112b: The server entity 200 receives the computational results as a function of the parameter vector from the agent entities 300a:300K.

S110c: The server entity 200 updates the parameter vector as a function of an aggregate of the received computational results.

Step S112 (including S112a: S112c) can be repeated until a termination criterion is met. The termination criterion in some non-limiting examples can be when a pre-determined number of iterations have been reached, when an aggregated loss function has reached a desired value, or when the aggregated loss function does not decrease after one (or several round) of iterations. The loss function itself represents a prediction error, such as mean square error or mean absolute error.

In some embodiments, the level of interference is estimated as a function of measurements on test data communicated between the server entity 200 and the agent entities 300a:300K at the end of each iteration of the iterative learning process.

In some examples, the server entity 200 alternates between performing the iterative learning process according to herein disclosed embodiments and a conventional iterative learning process. In the conventional iterative learning process mutually orthogonal time/frequency resources can be allocated to the participating agent entities 300a:300K in order to determine to what extent the interference present when performing the iterative learning process affects the convergence. Based on this, the server entity 200 can obtain further information on the sensitivity of the model (and indirectly, about the interference situation). For example, if the O server entity 200 detects that a consistently larger decrease of the learning objective function when performing an iteration using the conventional iterative learning process as compared to an iteration where the herein disclosed embodiments are used, the server entity 200 can conclude that the model is very sensitive to interference and/or that there is high interference. In some examples, the server entity 200 switches to performing a conventional iterative learning process once a decrease in the learning objective function from one iteration to the next goes under a pre-determined threshold value.

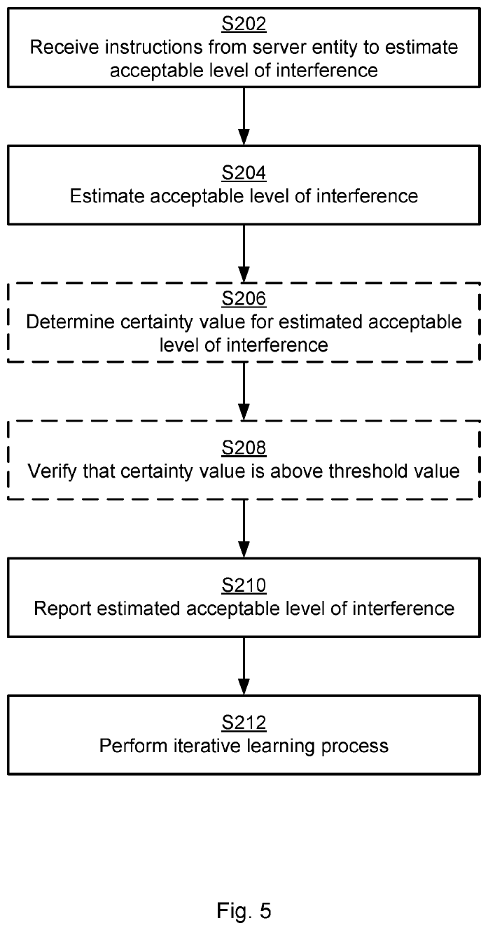

As disclosed above, the server entity 200 in (optional) S104 sends instructions to the agent entities 300a:300K to estimate the acceptable level of interference for the iterative learning process. The acceptable level of interference for the iterative learning process might thus be estimated by one or more of the agent entities 300a:300K. One advantage of involving one or more of the agent entities 300a:300K is that the estimation can be based on local, or private, data only residing in the agent entities 300a:300K. This will be disclosed next with reference to FIG. 5 illustrating a method for performing an iterative learning process with a server entity 200 as performed by the agent entity 300k according to an embodiment. The agent entity 300k is configured to communicate with the server entity 200 over a radio propagation channel.

S202: The agent entity 300k receives instructions from the server entity 200 to estimate the acceptable level of interference for the iterative learning process.

S204: The agent entity 300k estimates the acceptable level of interference for the iterative learning process.

S210: The agent entity 300k reports the estimated acceptable level of interference to the server entity 200.

S212: The agent entity 300k performs at least one iteration of the iterative learning process with the server entity 200. The at least one iteration is performed based on an interference mitigating network operation as determined as a function of the estimated acceptable level of interference.

Embodiments relating to further details of performing an iterative learning process with a server entity 200 as performed by the agent entity 300k will now be disclosed.

There could be different ways for the agent entity 300k to receive the instructions from the server entity 200 in S202. In some examples, the instructions are part of the model broadcast information. In some examples, the instructions are provided in a System Information Block (SIB).

There could be different ways for the agent entity 300k to report the estimated acceptable level of interference to the server entity 200 in S210. In some examples, the estimated acceptable level of interference is reported to the server entity 200 using radio resource control (RRC) signalling.

Aspects of how the agent entity 300k can estimate the acceptable level of interference for the iterative learning process will be disclosed next.

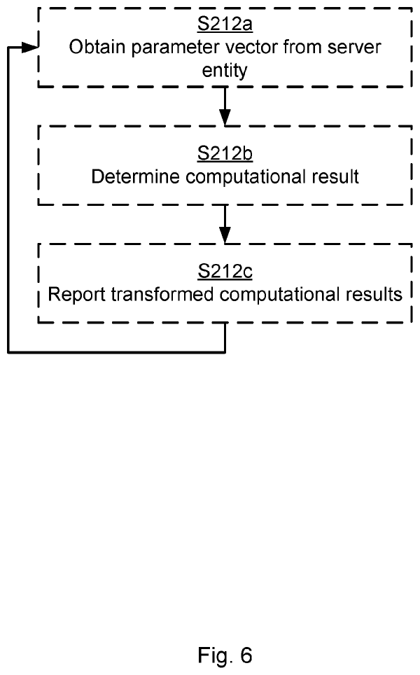

In some aspects, performing one iteration of the iterative learning process involves the agent entity 300k to send a model update of the iterative learning process to the server entity 200. Further aspects of this will be disclosed below with reference to FIG. 6.

In some aspects, the agent entity 300k adds a noise component, such as AWGN, to all, or a subset of, the weights of the model and estimates the impact of this noise component for N realizations. In particular, in some embodiments, the acceptable level of interference is estimated by adding a noise component to weights of the model update and estimating how much the noise component impacts the model update. In some embodiments, how much the noise component impacts the model update is determined using a model performance metric as used when a model to which the model update pertains is trained. For example, the absolute loss difference can be determined in terms of mean squared error (MSE) or any other type of loss function used when training the model. The absolute loss difference might relate to model accuracy in case the iterative learning process pertains to a classification problem. Thus, in some examples, in case the iterative learning process pertains to a classification problem, the acceptable level of interference is estimated by a performance metric pertaining to at least one of: categorical cross-Entropy, classification accuracy, a confusion matrix, precision, recall, F1 score, receiver operating characteristic (ROC) area under curve (AUC), log-loss. Further, in case the iterative learning process pertains to a regression problem, the acceptable level of interference can be estimated by calculating the MSE or the mean absolute error.

Further, in some examples, the agent entity 300k measures the output variation for different perturbation weights, when using a pseudo-random input data to the model. The output from the model resulting from the weight having been perturbated can then be compared to the output from the model resulting from the weight not having being perturbated. The difference in the output thus represents how sensitive the model is to perturbations of the weights. In turn, this provides an estimate of the acceptable level of interference of the model.

Aspects of how the acceptable level of interference can be estimated will be disclosed next.

As above, in some non-limiting examples, the acceptable level of interference is estimated as a function of any of: convergence rate of the performed iterative learning process, measurements on test data inserted in the performed iterative learning process, the current number of iteration of the performed iterative learning process, any variation in output between consecutive iterations of the performed iterative learning process, the convergence rate of a historically performed iterative learning process.

Aspects of when the estimated acceptable level of interference is to be reported by the agent entity to the server entity 200 will be disclosed next.

In some embodiments, one value of the acceptable level of interference is estimated per each iteration of the iterative learning process. This enables the server entity 200 to adapt the interference mitigating network operation per each iteration of the iterative learning process.

In some embodiments, the acceptable level of interference is estimated prior to each iteration of the iterative learning process. This also enables the server entity 200 to adapt the interference mitigating network operation per each iteration of the iterative learning process.

In some aspects, the agent entity 300k only reports the estimated acceptable level of interference if the estimated acceptable level of interference satisfy some reliability criterion. In particular, in some embodiments, the agent entity 300k is configured to perform (optional) steps S206 and S208:

S206: The agent entity 300k determines a certainty value for the estimated acceptable level of interference.

S208: The agent entity 300k verifies that the certainty value is above a threshold value before reporting the estimated acceptable level of interference.

The agent entity 300k can be configured with the threshold value from the server entity 200. The threshold value can be sent to the agent entity 300k from the server entity 200 using RRC signalling. This corresponds to a triggered-based approach, where the agent entity 300k only feeds back information in case its sensitivity estimates are above a certain threshold value.

Reference is next made to the flowchart of FIG. 6 showing optional steps of one iteration of the iterative learning process that might be performed by the agent entity 300k during each iteration of the iterative learning process in S212.

S212a: The agent entity 300k obtains a parameter vector of the computational problem from the server entity 200.

S212b: The agent entity 300k determines the computational result of the computational task as a function of the obtained parameter vector for the iteration and of data locally obtained by the agent entity 300k.

S212c: The agent entity 300k reports the computational result to the server entity 200.

As disclosed above, in some embodiments, the interference mitigating network operation pertains to repetitive transmission of the model update from the agent entity 300k per each iteration of the iterative learning process. Hence, S212c might be performed more than once per each iteration.

Step S212 (including S212a: S212c) can be repeated until a termination criterion is met. The termination criterion in some non-limiting examples can be when a pre-determined number of iterations have been reached, when an aggregated loss function has reached a desired value, or when the aggregated loss function does not decrease after one (or several round) of iterations. The loss function itself represents a prediction error, such as mean square error or mean absolute error.

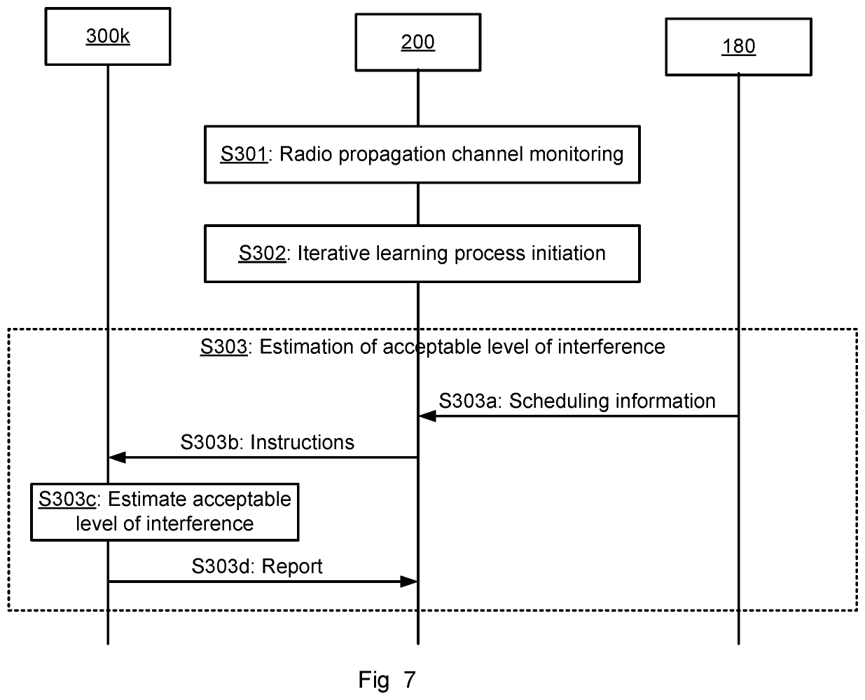

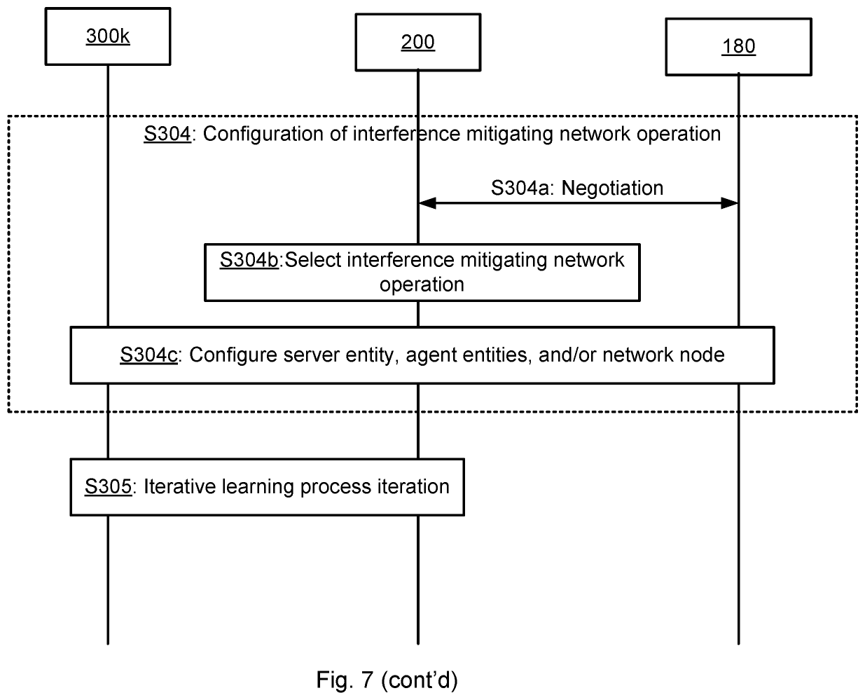

One particular embodiment for performing an iterative learning process based on at least some of the above disclosed embodiments will now be disclosed in detail with reference to the signalling diagram of FIG. 7.

S301: Radio propagation channel monitoring. The server entity 200 monitors the level of interference of the radio propagation channel between itself and the agent entities 300a:300K.

S302: Iterative learning process initiation. The server entity 200 initiates a new iteration of the iterative learning process.

S303: Estimation of the acceptable level of interference for the iterative learning process.

S303a: The network node 180 provides scheduling information to the server entity 200.

S303b: The server entity 200 sends instructions to the agent entities 300a:300K to estimate the acceptable level of interference for the iterative learning process.

S303c: The agent entities 300a:300K estimate the acceptable level of interference for the iterative learning process

S303d: The agent entities 300a:300K report the estimated acceptable level of interference to the server entity 200.

S304: Configuration of interference mitigating network operation.

S304a: The server entity 200 negotiates with the network node 180 with respect to candidate time/frequency resources for which the network node 180 can reduce its transmission power and/or to which level the transmission power of the candidate time/frequency resources can be reduced.

S304b: The server entity 200, based on the estimate of the acceptable level of interference, the estimate of the level of interference, and the result of the negotiation with the network node 180, selects an interference mitigating network operation.

S304c: The server entity 200 configures, in accordance with the interference mitigating network operation, at least one of: the server entity 200, the agent entities 300a:300K, a network node 180 causing the level of interference level.

S305: Iterative learning process iteration. The server entity 200 performs at least one iteration of the iterative learning process with the agent entities 300a:300K.

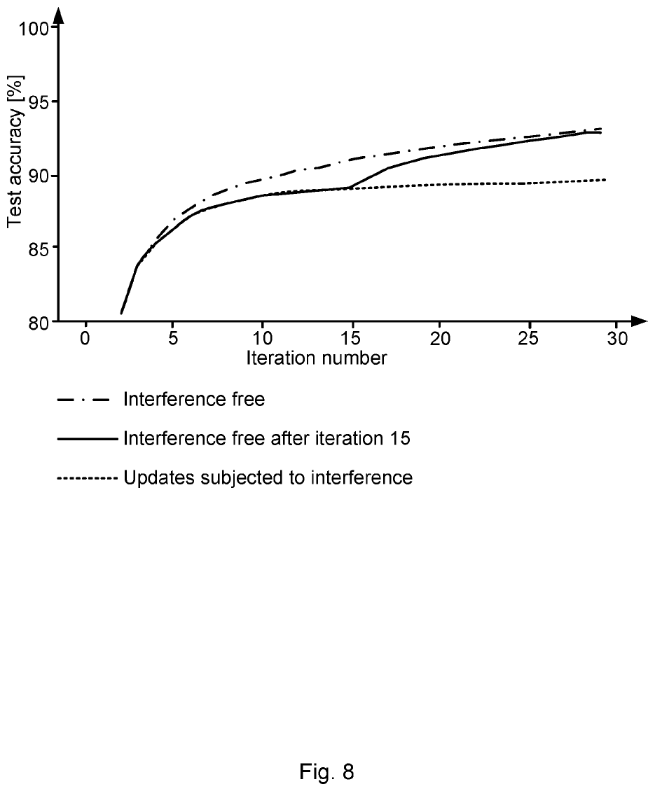

Simulation results will be disclosed next with reference to FIG. 8. The simulation results represent a scenario where the iterative learning process pertains to training an ML-model to perform digit classification, using the Modified National Institute of Standards and Technology (MNIST) dataset. In the scenario, five agent entities were used by a server entity to train a digit classifier using an iterative learning process as herein disclosed. The classifier comprises of a feed-forward neural network with parameters listed in Table 1, including 118282 parameters in total (all trainable). The model input is an image, where the image is represented by 28-by-28 pixels, resulting in a model input represented by 784 floating point values. Each agent entity has access to a unique training dataset comprising 2000 images, with correct corresponding labels (0-9). The training dataset is used to train/update the local ML-model of each agent entity in each training iteration. Also, each agent entity has access to a unique test dataset that comprises another set of 2000 images, with corresponding labels (0-9).

TABLE 1
Neural network parameters

| Layer (type) | Output shape | Number of parameters |
|---|---|---|
| Dense_961 (Dense) | (None, 128) | 100480 |
| Dropout_641 (Dropout) | (None, 128) | 0 |
| Dense_962 (Dense) | (None, 128) | 16512 |
| Dropout_642 (Dropout) | (None, 128) | 0 |
| Dense_963 (Dense) | (None, 10) | 1290 |

The model updates as sent by the agent entities towards the server entity were subject to interference from data transmissions/receptions in an interfering network node. A first set of results was obtained for a first scenario where an iterative learning process was evaluated by modeling the interference caused by the interfering network node to the iterative learning process as additive white Gaussian noise (AWGN). The AWGN was added to all model weights. A second set of results was obtained for a second scenario without any interference (i.e., for an interference-free scenario). This interference-free scenario provides an upper bound on the performance for the given ML model, network parameters, level of interference, etc. A third set of results was obtained for a third scenario where the source of interference was muted after iteration number 15, thus resulting in interference free updates after iteration number 15. As can be seen in FIG. 8, the results for the different scenarios are quite similar for the first five iterations. This implies that a potential muting of transmissions from the interfering network node is unnecessary. After five iterations, the results show how the accuracy for the noise free updates is improve more than for the updates subject to AWGN. Muting the interfering network node after iteration 15 causes the results of the third scenario to converge to the results of the second scenario (i.e., the interference-free scenario).

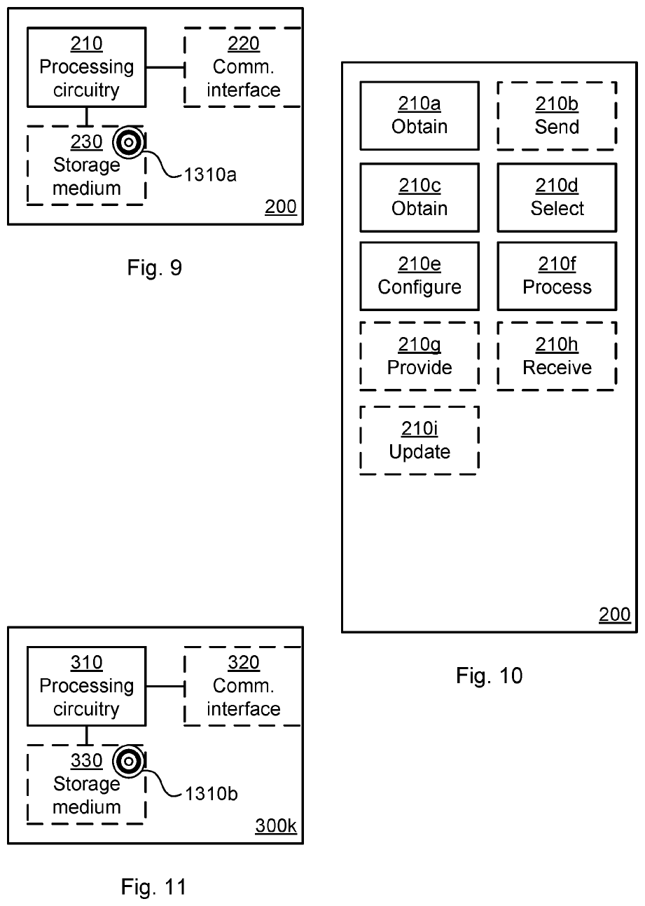

FIG. 9 schematically illustrates, in terms of a number of functional units, the components of a server entity 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 1310a (as in FIG. 13), e.g. in the form of a storage medium 230. The processing circuitry 210 may further be provided as at least one application specific integrated circuit (ASIC), or field programmable gate array (FPGA).

Particularly, the processing circuitry 210 is configured to cause the server entity 200 to perform a set of operations, or steps, as disclosed above. For example, the storage medium 230 may store the set of operations, and the processing circuitry 210 may be configured to retrieve the set of operations from the storage medium 230 to cause the server entity 200 to perform the set of operations. The set of operations may be provided as a set of executable instructions. Thus the processing circuitry 210 is thereby arranged to execute methods as herein disclosed.

The storage medium 230 may also comprise persistent storage, which, for example, can be any single one or combination of magnetic memory, optical memory, solid state memory or even remotely mounted memory.

The server entity 200 may further comprise a communications interface 220 for communications with other entities, functions, nodes, and devices, either directly or indirectly. As such the communications interface 220 may comprise one or more transmitters and receivers, comprising analogue and digital components.

The processing circuitry 210 controls the general operation of the server entity 200 e.g. by sending data and control signals to the communications interface 220 and the storage medium 230, by receiving data and reports from the communications interface 220, and by retrieving data and instructions from the storage medium 230. Other components, as well as the related functionality, of the server entity 200 are omitted in order not to obscure the concepts presented herein.

FIG. 10 schematically illustrates, in terms of a number of functional modules, the components of a server entity 200 according to an embodiment. The server entity 200 of FIG. 10 comprises a number of functional modules; an obtain module 210a configured to perform step S102, an obtain module 210c configured to perform step S106, a select module 210d configured to perform step S108, a configure module 210e configured to perform step S110, and a process module 210f configured to perform step S112. The server entity 200 of FIG. 10 may further comprise a number of optional functional modules, such as any of a send module 210a configured to perform step S104, a provide module 210g configured to perform step S112a, a receive module 210h configured to perform step S112b, and an update module 210i configured to perform step S112c.

In general terms, each functional module 210a:210i may be implemented in hardware or in software. Preferably, one or more or all functional modules 210a:210i may be implemented by the processing circuitry 210, possibly in cooperation with the communications interface 220 and/or the storage medium 230. The processing circuitry 210 may thus be arranged to from the storage medium 230 fetch instructions as provided by a functional module 210a:210i and to execute these instructions, thereby performing any steps of the server entity 200 as disclosed herein.

The server entity 200 may be provided as a standalone device or as a part of at least one further device. For example, the server entity 200 may be provided in a node of the radio access network or in a node of the core network. Alternatively, functionality of the server entity 200 may be distributed between at least two devices, or nodes. These at least two nodes, or devices, may either be part of the same network part (such as the radio access network or the core network) or may be spread between at least two such network parts. In general terms, instructions that are required to be performed in real time may be performed in a device, or node, operatively closer to the cell than instructions that are not required to be performed in real time. Thus, a first portion of the instructions performed by the server entity 200 may be executed in a first device, and a second portion of the instructions performed by the server entity 200 may be executed in a second device; the herein disclosed embodiments are not limited to any particular number of devices on which the instructions performed by the server entity 200 may be executed. Hence, the methods according to the herein disclosed embodiments are suitable to be performed by a server entity 200 residing in a cloud computational environment. Therefore, although a single processing circuitry 210 is illustrated in FIG. 9 the processing circuitry 210 may be distributed among a plurality of devices, or nodes. The same applies to the functional modules 210a:210i of FIG. 10 and the computer program 1320a of FIG. 13.

FIG. 11 schematically illustrates, in terms of a number of functional units, the components of an agent entity 300k according to an embodiment. Processing circuitry 310 is provided using any combination of one or more of a suitable central processing unit (CPU), multiprocessor, microcontroller, digital signal processor (DSP), etc., capable of executing software instructions stored in a computer program product 1310b (as in FIG. 13), e.g. in the form of a storage medium 330. The processing circuitry 310 may further be provided as at least one application specific integrated circuit (ASIC), or field programmable gate array (FPGA).

Particularly, the processing circuitry 310 is configured to cause the agent entity 300k to perform a set of operations, or steps, as disclosed above. For example, the storage medium 330 may store the set of operations, and the processing circuitry 310 may be configured to retrieve the set of operations from the storage medium 330 to cause the agent entity 300k to perform the set of operations. The set of operations may be provided as a set of executable instructions. Thus the processing circuitry 310 is thereby arranged to execute methods as herein disclosed.

The storage medium 330 may also comprise persistent storage, which, for example, can be any single one or combination of magnetic memory, optical memory, solid state memory or even remotely mounted memory.

The agent entity 300k may further comprise a communications interface 320 for communications with other entities, functions, nodes, and devices, either directly or indirectly. As such the communications interface 320 may comprise one or more transmitters and receivers, comprising analogue and digital components.

The processing circuitry 310 controls the general operation of the agent entity 300k e.g. by sending data and control signals to the communications interface 320 and the storage medium 330, by receiving data and reports from the communications interface 320, and by retrieving data and instructions from the storage medium 330. Other components, as well as the related functionality, of the agent entity 300k are omitted in order not to obscure the concepts presented herein.

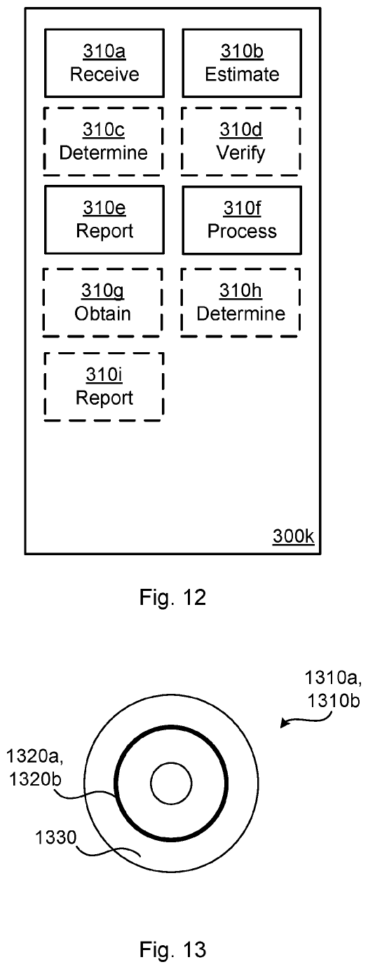

FIG. 12 schematically illustrates, in terms of a number of functional modules, the components of an agent entity 300k according to an embodiment. The agent entity 300k of FIG. 12 comprises a number of functional modules; a receive module 310a configured to perform step S202, an estimate module 310b configured to perform step S204, a report module 310e configured to perform step S210, and a process module 310f configured to perform step S212. The agent entity 300k of FIG. 12 may further comprise a number of optional functional modules, such as any of a determine module 310c configured to perform step S206, a verify module 310d configured to perform step S208, an obtain module 310g configured to perform step S212a, a determine module 310h configured to perform step S212b, and a report module 310i configured to perform step S212c. In general terms, each functional module 310a: 310i may be implemented in hardware or in software. Preferably, one or more or all functional modules 310a: 310i may be implemented by the processing circuitry 310, possibly in cooperation with the communications interface 320 and/or the storage medium 330. The processing circuitry 310 may thus be arranged to from the storage medium 330 fetch instructions as provided by a functional module 310a: 310i and to execute these instructions, thereby performing any steps of the agent entity 300k as disclosed herein.

FIG. 13 shows one example of a computer program product 1310a, 1310b comprising computer readable means 1330. On this computer readable means 1330, a computer program 1320a can be stored, which computer program 1320a can cause the processing circuitry 210 and thereto operatively coupled entities and devices, such as the communications interface 220 and the storage medium 230, to execute methods according to embodiments described herein. The computer program 1320a and/or computer program product 1310a may thus provide means for performing any steps of the server entity 200 as herein disclosed. On this computer readable means 1330, a computer program 1320b can be stored, which computer program 1320b can cause the processing circuitry 310 and thereto operatively coupled entities and devices, such as the communications interface 320 and the storage medium 330, to execute methods according to embodiments described herein. The computer program 1320b and/or computer program product 1310b may thus provide means for performing any steps of the agent entity 300k as herein disclosed.

In the example of FIG. 13, the computer program product 1310a, 1310b is illustrated as an optical disc, such as a CD (compact disc) or a DVD (digital versatile disc) or a Blu-Ray disc. The computer program product 1310a, 1310b could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 1320a, 1320b is here schematically shown as a track on the depicted optical disk, the computer program 1320a, 1320b can be stored in any way which is suitable for the computer program product 1310a, 1310b.

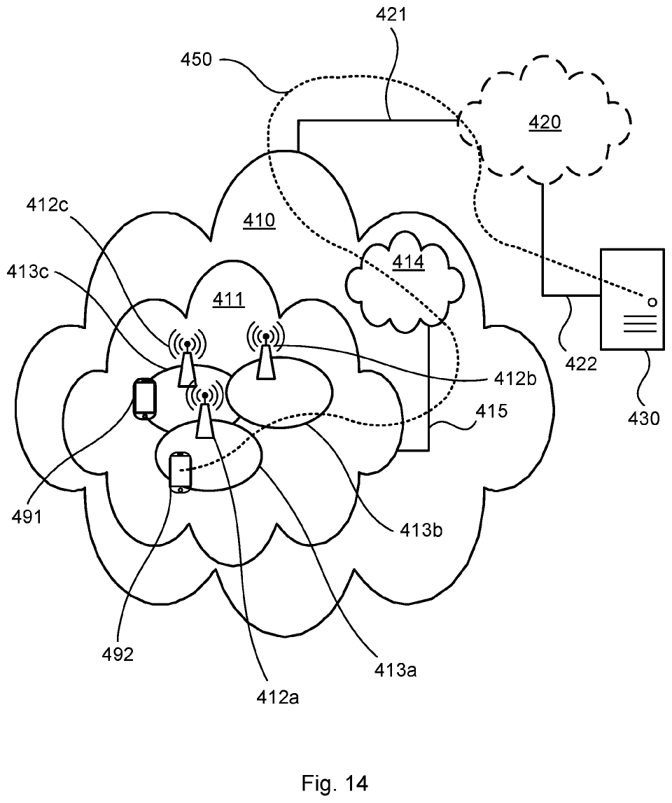

FIG. 14 is a schematic diagram illustrating a telecommunication network connected via an intermediate network 420 to a host computer 430 in accordance with some embodiments. In accordance with an embodiment, a communication system includes telecommunication network 410, such as a 3GPP-type cellular network, which comprises access network 411, such as radio access network 110 in FIG. 1, and core network 414, such as core network 120 in FIG. 1. Access network 411 comprises a plurality of radio access network nodes 412a, 412b, 412c, such as NBs, eNBs, gNBs (each corresponding to the network node 160 of FIG. 1) or other types of wireless access points, each defining a corresponding coverage area, or cell, 413a, 413b, 413c. Each radio access network nodes 412a, 412b, 412c is connectable to core network 414 over a wired or wireless connection 415. A first UE 491 located in coverage area 413c is configured to wirelessly connect to, or be paged by, the corresponding network node 412c. A second UE 492 in coverage area 413a is wirelessly connectable to the corresponding network node 412a. While a plurality of UE 491, 492 are illustrated in this example, the disclosed embodiments are equally applicable to a situation where a sole UE is in the coverage area or where a sole terminal device is connecting to the corresponding network node 412. The UEs 491, 492 correspond to the UEs 170a:170K of FIG. 1.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider, or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 14 as a whole enables connectivity between the connected UEs 491, 492 and host computer 430. The connectivity may be described as an over-the-top (OTT) connection 450. Host computer 430 and the connected UEs 491, 492 are configured to communicate data and/or signalling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, network node 412 may not or need not be informed about the past routing of an incoming downlink communication with data originating from host computer 430 to be forwarded (e.g., handed over) to a connected UE 491. Similarly, network node 412 need not be aware of the future routing of an outgoing uplink communication originating from the UE 491 towards the host computer 430.

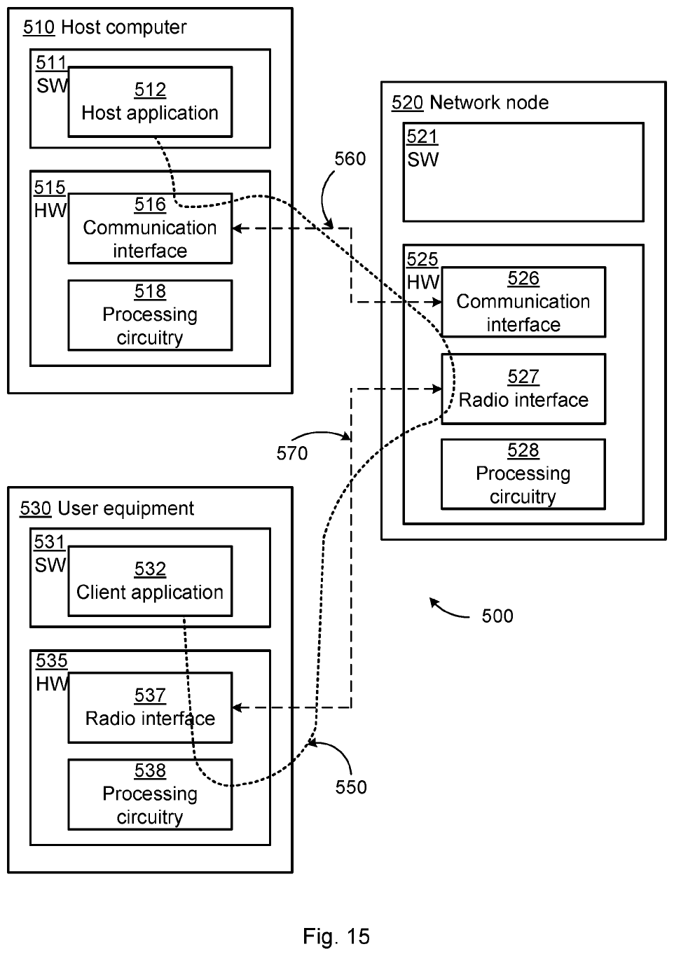

FIG. 15 is a schematic diagram illustrating host computer communicating via a radio access network node with a UE over a partially wireless connection in accordance with some embodiments. Example implementations, in accordance with an embodiment, of the UE, radio access network node and host computer discussed in the preceding paragraphs will now be described with reference to FIG. 15. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. The UE 530 corresponds to the UEs 170a:170K of FIG. 1. In providing the service to the remote user, host application 512 may provide user data which is transmitted using OTT connection 550.

Communication system 500 further includes radio access network node 520 provided in a telecommunication system and comprising hardware 525 enabling it to communicate with host computer 510 and with UE 530. The radio access network node 520 corresponds to the network node 160 of FIG. 1. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 15) served by radio access network node 520. Communication interface 526 may be configured to facilitate connection 560 to host computer 510. Connection 560 may be direct or it may pass through a core network (not shown in FIG. 15) of the telecommunication system and/or through one or more intermediate networks outside the telecommunication system. In the embodiment shown, hardware 525 of radio access network node 520 further includes processing circuitry 528, which may comprise one or more programmable processors, application-specific integrated circuits, field programmable gate arrays or combinations of these (not shown) adapted to execute instructions. Radio access network node 520 further has software 521 stored internally or accessible via an external connection.

Communication system 500 further includes UE 530 already referred to. Its hardware 535 may include radio interface 537 configured to set up and maintain wireless connection 570 with a radio access network node serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, radio access network node 520 and UE 530 illustrated in FIG. 15 may be similar or identical to host computer 430, one of network nodes 412a, 412b, 412c and one of UEs 491, 492 of FIG. 14, respectively. This is to say, the inner workings of these entities may be as shown in FIG. 15 and independently, the surrounding network topology may be that of FIG. 14.

In FIG. 15, OTT connection 550 has been drawn abstractly to illustrate the communication between host computer 510 and UE 530 via network node 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., on the basis of load balancing consideration or reconfiguration of the network).

Wireless connection 570 between UE 530 and radio access network node 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may reduce interference, due to improved classification ability of airborne UEs which can generate significant interference.

A measurement procedure may be provided for the purpose of monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above, or supplying values of other physical quantities from which software 511, 531 may compute or estimate the monitored quantities. The reconfiguring of OTT connection 550 may include message format, retransmission settings, preferred routing etc.; the reconfiguring need not affect network node 520, and it may be unknown or imperceptible to radio access network node 520. Such procedures and functionalities may be known and practiced in the art. In certain embodiments, measurements may involve proprietary UE signalling facilitating host computer's 510 measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for performing an iterative learning process with agent entities, the method being performed by a server entity, the server entity communicating with the agent entities over a radio propagation channel, the method comprising:
obtaining an estimate of a level of interference of the radio propagation channel;
obtaining an estimate of an acceptable level of interference for performing at least one iteration of the iterative learning process with the agent entities;
selecting an interference mitigating network operation from a set of available interference mitigating network operations, wherein the interference mitigating network operation is selected as a function of the estimate of the acceptable level of interference and the estimate of the level of interference;
configuring, in accordance with the interference mitigating network operation, at least one of: the server entity, the agent entities, a network node causing the level of interference level; and
performing at least one iteration of the iterative learning process with the agent entities.

2. The method according to claim 1, wherein the interference mitigating network operation is associated with which time/frequency resources are to be used by one of: the server entity, the agent entities, the network node when the at least one iteration of the iterative learning process is performed, and wherein, according to the interference mitigating network operation, a smallest set of time/frequency resources as required for maintaining the acceptable level of interference is selected.

3. The method according to claim 1, wherein the interference mitigating network operation pertains to transmission power used by the network node, and wherein the network node is configured with the interference mitigating network operation by being requested to reduce transmission power in time/frequency resources causing the level of interference.

4. The method according to claim 1, wherein performing one iteration of the iterative learning process involves each of the agent entities to send a respective model update of the iterative learning process to the server entity, and wherein the interference mitigating network operation pertains to repetitive transmission of the model update from the agent entities per said at least one iteration of the iterative learning process.

5. The method according to claim 1, wherein performing one iteration of the iterative learning process involves each of the agent entities to send a respective model update of the iterative learning process to the server entity, and wherein the interference mitigating network operation pertains to applying interference suppression when receiving the model updates from the agent entities during said at least one iteration of the iterative learning process.

6. The method according to claim 1, wherein the level of interference is estimated as a function of any of: scheduling information received from the network node, measurements on signals received from the network node, a historically experienced level of interference of the radio propagation channel.

7. The method according to claim 1, wherein the level of interference is estimated as a function of measurements on test data communicated between the server entity and the agent entities at the end of each iteration of the iterative learning process.

8. The method according to claim 1, wherein the estimate of the acceptable level of interference is obtained either by the acceptable level of interference being estimated by the server entity or by the estimate of the acceptable level of interference being received from the agent entities.

9. The method according to claim 1, wherein the method further comprises:
sending instructions to the agent entities to estimate the acceptable level of interference for the iterative learning process, and wherein the estimate of the acceptable level of interference is received from the agent entities in response thereto.

10. The method according to claim 1, wherein the acceptable level of interference is estimated as a function of any of: convergence rate of the performed iterative learning process, measurements on test data inserted in the performed iterative learning process, current number of iteration of the performed iterative learning process, variation in output between consecutive iterations of the performed iterative learning process, convergence rate of a historically performed iterative learning process.

11. The method according to claim 1, wherein the iterative learning process involves the use of a neural network, wherein the neural network has layers, wherein at least one layer is activated during each iteration of the iterative learning process, and wherein the acceptable level of interference is estimated as a function of which of the layers the at least one iteration of the iterative learning process pertains to.

12. A method for performing an iterative learning process with a server entity, the method being performed by an agent entity, the agent entity communicating with the server entity over a radio propagation channel, the method comprising:
receiving instructions from the server entity to estimate the acceptable level of interference for the iterative learning process;
estimating the acceptable level of interference for the iterative learning process;
reporting the estimated acceptable level of interference to the server entity; and
performing at least one iteration of the iterative learning process with the server entity, wherein said at least one iteration is performed based on an interference mitigating network operation as determined as a function of the estimated acceptable level of interference.

13. The method according to claim 12, wherein performing one iteration of the iterative learning process involves the agent entity to send a model update of the iterative learning process to the server entity.

14. The method according to claim 13, wherein the interference mitigating network operation pertains to repetitive transmission of the model update from the agent entity per said at least one iteration of the iterative learning process.

15. The method according to claim 13, wherein the acceptable level of interference is estimated by adding a noise component to weights of the model update and estimating how much the noise component impacts the model update.

16. The method according to claim 15, wherein how much the noise component impacts the model update is determined using a model performance metric as used when a model to which the model update pertains is trained.

17. The method according to claim 12, wherein the acceptable level of interference is estimated as a function of any of: convergence rate of the performed iterative learning process, measurements on test data inserted in the performed iterative learning process, current number of iteration of the performed iterative learning process, variation in output between consecutive iterations of the performed iterative learning process, convergence rate of a historically performed iterative learning process.

18. The method according to claim 12, wherein one value of the acceptable level of interference is estimated per each iteration of the iterative learning process.

19. (canceled)

20. (canceled)

21. A server entity for performing an iterative learning process with agent entities, the server entity being configured to communicate with the agent entities over a radio propagation channel, the server entity comprising processing circuitry, the processing circuitry being configured to cause the server entity to:
obtain an estimate of a level of interference of the radio propagation channel;
obtain an estimate of an acceptable level of interference for performing at least one iteration of the iterative learning process with the agent entities;
select an interference mitigating network operation from a set of available interference mitigating network operations, wherein the interference mitigating network operation is selected as a function of the estimate of the acceptable level of interference and the estimate of the level of interference;
configure, in accordance with the interference mitigating network operation, at least one of: the server entity, the agent entities, a network node causing the level of interference level; and
perform at least one iteration of the iterative learning process with the agent entities.

22. A server entity for performing an iterative learning process with agent entities, the server entity being configured to communicate with the agent entities over a radio propagation channel, the server entity comprising:
an obtain module configured to obtain an estimate of a level of interference of the radio propagation channel;
an obtain module configured to obtain an estimate of an acceptable level of interference for performing at least one iteration of the iterative learning process with the agent entities;
a select module configured to select an interference mitigating network operation from a set of available interference mitigating network operations, wherein the interference mitigating network operation is selected as a function of the estimate of the acceptable level of interference and the estimate of the level of interference;
a configure module configured to configure, in accordance with the interference mitigating network operation, at least one of: the server entity, the agent entities, a network node causing the level of interference level; and
a process module configured to perform at least one iteration of the iterative learning process with the agent entities.

23.-29. (canceled)
